(19) United States
(12) Patent Application Publication
(10) Pub. No.: US 2020/0386007 A1
(43) Pub. Date: Dec. 10, 2020

(54) SECURITY MOUNTING BRACKET DEVICE FOR A CROSSBAR

(71) Applicant: Ian William Lane-Lohse, San Diego, CA (US)

(72) Inventor: Ian William Lane-Lohse, San Diego, CA (US)

(21) Appl. No.: 16/857,160

(22) Filed: Apr. 23, 2020

Related U.S. Application Data
(60) Provisional application No. 62/837,692, filed on Apr. 23, 2019.

(51) Int. Cl. E04H 15/34; E04H 15/06

(52) U.S. Cl. CPC E04H 15/34; B60P 3/32; E04H 15/06

(57) ABSTRACT

Provided herein is a security mounting bracket device that can be used to securely connect a crossbar to a mounted object. The device is shaped to form a contoured fit with the crossbar and adapted for use with a security nut and bolt rendering both nut and bolt unexposed outside of the device and inaccessible to tools that may be used to forcibly remove the mounted object. The security mounting bracket device can be used as an antitheft device as a security socket is required to remove the nut form the security mounting bracket. The contoured fit reduces the movement of the crossbar within the security mounting bracket device therefore reducing vibrationally induced failure of the mount and loss of mounted object. The security mounting bracket device smooth edges and unexposed nut and bolt also make it a safer bracket for the user in assembly. The size and contour of the security mounting bracket device can be customized to connect any shape of a crossbar to a mounted object such as a guide rail attached to a platform or to a platform directly. The crossbar can be mounted perpendicularly or at other angles, to the security mounting bracket device or and can be used to connect a plurality of mounted objects for example platforms for tents or cargo containers.

### CROSS-REFERENCE TO RELATED APPLICATIONS

Benefit of priority is claimed to U.S. Provisional Application No. 62/837,692, filed Apr. 23, 2019, entitled “Rooftop Tent Crossbar Anti-Theft Mount”. The subject matter of the above noted application is incorporated by reference in its entirety.

### FIELD OF THE INVENTION

Provided herein is a security mounting bracket device that can be used to connect a cross bar to an object to be mounted such as a cartop tent, a cargo box or a bike rack.

### BACKGROUND

Camping outdoors is a worldwide hobby and a car rooftop tent offers some unique advantages that include easy set-up, safer off the ground location and the flexibility to set up camp anywhere. Plans on how to make a car-top tent can be found on the web and many top brand camping gear manufacturers now provide car roof top tent in their product lines. The hardware used to attach the tent to a car roof rack may be a simple plate, nut, and bolt system or a specialized bracket which is typically easy to remove or leaving a section of a bolt exposed and easily accessible. A bolt cutter can snap the connections in minutes and the tent becomes an easy target for theft. The various mounting hardware also may fail when a car goes off road and the mounted cargo start to angulate.

Thus there is a need for a crossbar mount for vehicle rooftop tents, and other systems to be mounted, that is durable and easy to use, conforms to the shape of various platforms and racks, without compromising the integrity of the mounting bracket device and that protects the mounted system such as a rooftop tent from theft and from vibrating off the mounted structure.

### REFERENCE NUMERALS LIST

The following list indicates the terms used and the corresponding reference numerals. Reference to each should be made with respect to the description below and the accompanying Drawings.

10 security mounting bracket device

12 security mounting bracket device mounting post

12'central security mounting bracket device mounting post

13 bridge of the security mount

14 counterbore hole well

20 counterbore hole bolt entry end

3h height of mounting post

3w length of security mounting bracket devise

3r height of security mounting bracket devise

3s width of security mounting bracket devise

3t width of tunnel

3x distance between borehole centers

3y diameter of counterbore hole bolt entry end

3z diameter of counterbore hole well

3q height of tunnel

3u depth of counterbore hole bolt entry end

3v width of tunnel

40 security nut

41 threaded bore hole of the security nut

42 groove of security nut

51 bolt

52 mounting channel slide

60 mounting rail

61 channel of the mounting rail

70 crossbar

80 security mounting bracket device with a wide contoured fit bridge

81 bridge of security mounting bracket device 80

82 mounting post of security mounting bracket device 80

85 security mounting bracket device with rectangular shaped contoured fit bridge

86 bridge of security mounting bracket device 80

87 mounting post of security mounting bracket device 80

90 security mounting bracket device with a wide contoured fit bridge

91 bridge of security mounting bracket device 90

92 mounting post of security mounting bracket device 90

93 flat grooved crossbar

100 security mounting bracket device for a two crossbar attachment

101 bridge of a security mounting bracket device 100

### SUMMARY

Provided herein is a security mounting bracket device for mounting an object to a crossbar, the security mounting bracket device includes a single piece of molded material having one or more bridge portions each bridge portion positioned between two mounting posts wherein each mounting post having a top portion and a bottom portion; a counterbore hole centered within each mounting post, spanning the height of each post, wherein a first portion comprises a counterbore hole well positioned in the top portion of the mounting post connected to the bridge portion and is dimensioned for placement of a nut below the surface of the post, and the second portion comprises counterbore hole bolt entry end positioned in the bottom portion of the mounting post; and wherein the bridge and two mounting posts form a contoured tunnel matching the contour and dimensions of the crossbar. The security mounting bracket device further includes material that will not be altered by ambient heat and pressure exerted by the cross bar and mounted object. Yet further embodiment of the security mounting bracket device include material is a hard metal, metal alloy, composite material, polymers including material selected from among aluminum, steel, titanium, zinc alloys and hard plastic.

Provided herein is a security mounting bracket device wherein the width of the security mounting bracket device as measured form the outer portion of the mounting posts is from or from about 1.0 in to 10.0 or 1.0 in to 24.0 in or 1.0 ft to 5.0 ft and is determined but the width or diameter of the crossbar; wherein the counterbore hole well has a depth between 0.2 in and 1.0 in, or 0.3 in and 0.9 in, or 0.4 and 0.8 in or 1.0 in to 2 in or 2.0 in to 10 in.

In yet another embodiment the security mounting bracket device includes; two bridge portions with three post portions with the two bridges connected to a shared central post that optionally includes a counterbore hole; and/or includes walls of the contoured tunnel formed by the bridge and mounting posts is perpendicular to the alignment of the posts of the security mounting bracket; and/or the security mounting bracket device of wherein the walls of the contoured tunnel formed by the post are parallel and not perpendicular to the alignment of the posts of the security mounting bracket; and/or includes walls of the contoured tunnel formed by the bridge and posts are parallel and form an angle that is less than 90° with the alignment of the posts of the security mounting bracket.

In yet further embodiments a method of mounting an object fitted with a mounting rail to a crossbar includes:

using the security mounting bracket device of includes: step a) placing a bolt through a hole of mounting channel slide and inserting the mounting channel slide into the channel of the mounting rail wherein the head of the bolt is positioned between the mounting channel slide and the mounting rail leaving the unthreaded and threaded shank exposed beneath the mounting channel slide; step b) repeating step a) with a second bolt and aligning the two bolts suspended from the mounting rail a distance equal to the distance between two counterbore bolt entry holes of a security mounting bracket device; step c) straddling a crossbar, perpendicular to and below the mounting channel rail, with the security mounting bracket device, inserting the two bolts through the two post of the security mounting bracket device positioning the threaded shank of the bolt within the well of the counterbore hole; and step d) using a nut and socket, placing the nut onto the threader shank of the bolt and tightening the nut onto the bolt and forming a bolted joint between the security mounting bracket device and the mounting channel rail; and wherein a bolted join is formed between teach of two security mounting bracket devices and mounting rail. Further the nut is optionally selected from among security nut and a nylon-insert lock nut.

In yet another embodiment a method of mounting an object fitted with two mounting rails to a crossbar includes: using the security mounting bracket device includes: placing a bolt through a hole of mounting channel slide and inserting the mounting channel slide into the channel of a first mounting rail wherein the head of the bolt is positioned between the mounting channel slide and the first mounting rail leaving the unthreaded and threaded shank exposed beneath the mounting channel slide; repeating step a) with a second bolt and aligning the two bolts suspended from the mounting rail a distance equal to the distance between two counterbore bolt entry holes of a security mounting bracket device; straddling a crossbar, perpendicular to and below the first mounting rail, with the security mounting bracket device, inserting two bolts through the two post of the security mounting bracket device positioning the threaded shank of the bolt within the well of the counterbore hole; using a nut and socket, placing the nut onto the threader shank of the bolt and tightening the nut onto the bolt and forming a bolted joint between the security mounting bracket device and the first mounting rail, wherein a bolted join is formed between teach of two security mounting bracket devices and mounting rail; repeating steps a)-d) with a second mounting rail and a second set of bolts, nuts, mounting channel guides; and wherein a bolted join is formed between teach of four security mounting bracket devices and two mounting rail. Further the nut is optionally selected from among security nut and a nylon-insert lock nut and wherein the mounted object is selected from among vehicle top tent, a bike rack, a cargo box.

### BRIEF DESCRIPTION OF THE DARWINGS

The drawings described herein are for illustrative purposes only of selected embodiments and not all possible implementations, and are not intended to limit the scope of the present disclosure.

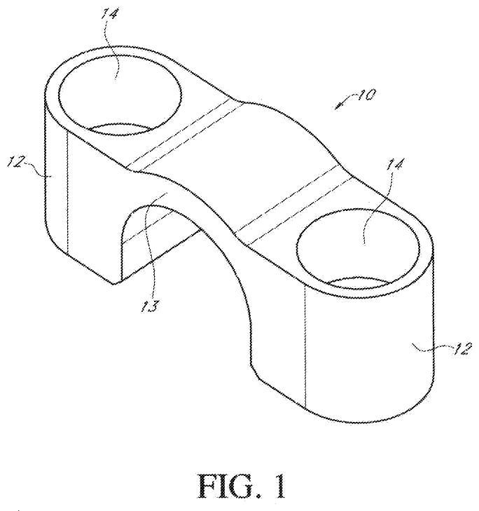

FIG. 1 is a perspective top view of security mounting bracket device with rounded bridge.

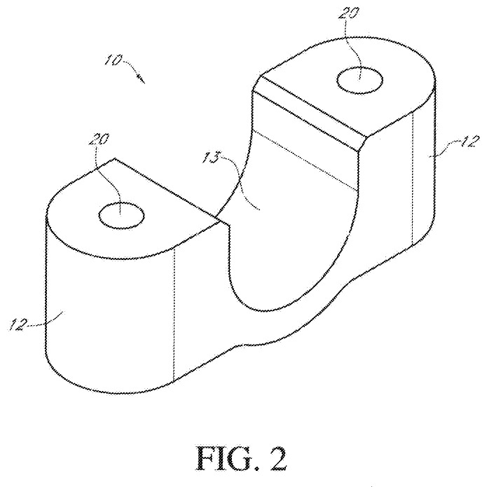

FIG. 2 is a perspective bottom view of security mounting bracket device with rounded bridge.

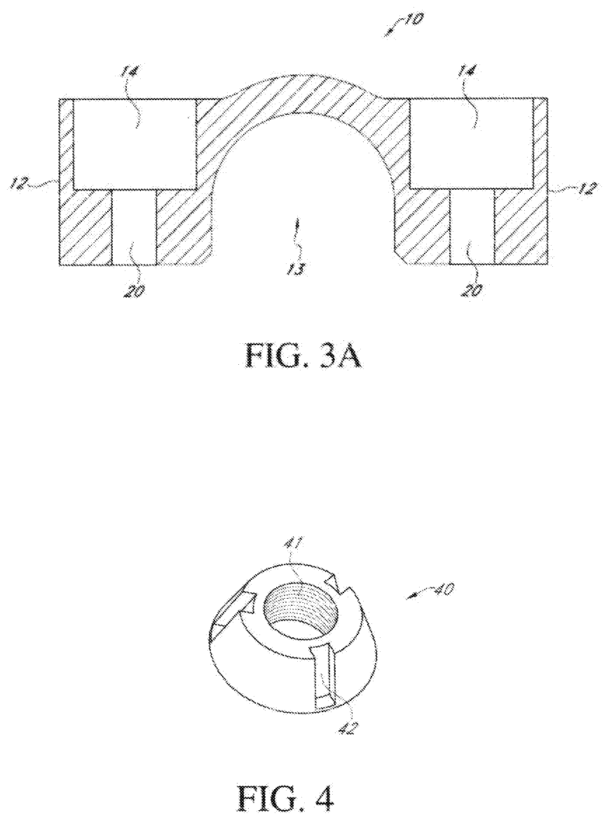

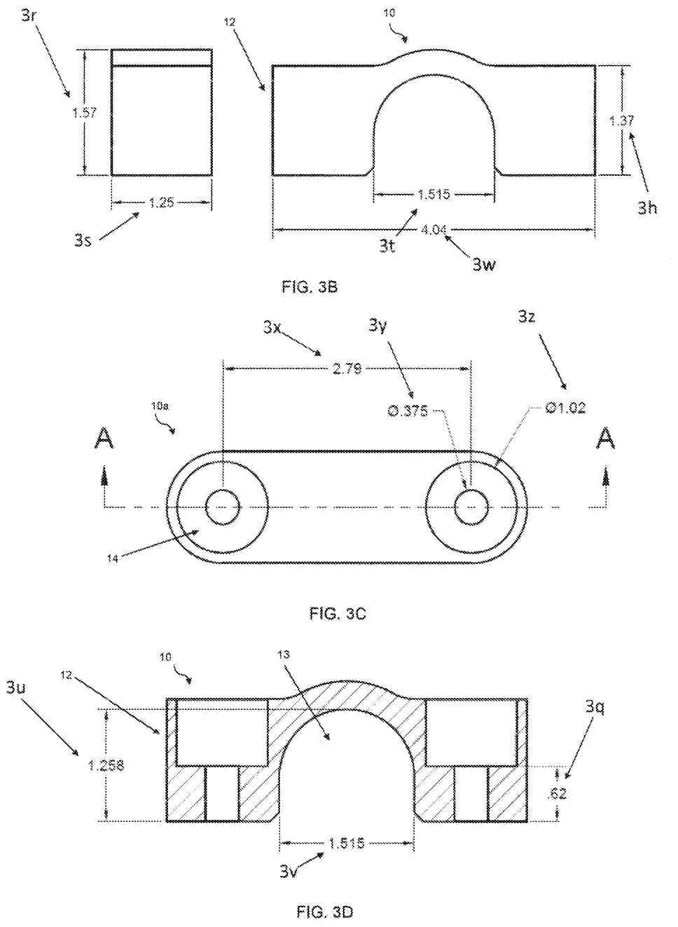

FIG. 3A is a side cross sectional view of security mounting bracket device with rounded bridge.

FIG. 3B is a frontal view of security mounting bracket device with dimensions of an exemplary device.

FIG. 3C is a top view of security mounting bracket device with the counterbore of an exemplary the counter dimensions of an exemplary device.

FIG. 3D is a frontal view of security mounting bracket device with the counterbore dimensions of an exemplary device.

FIG. 4 is a perspective top view of an exemplary security nut for attachment of the security mounting bracket.

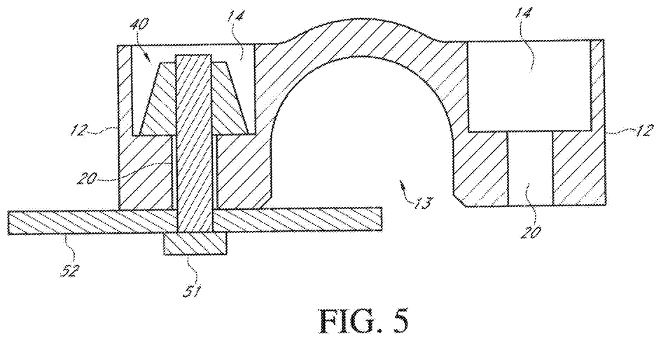

FIG. 5 is a frontal cross sectional view of a rounded bridge security mounting bracket, with a mounting channel slide connected to one mounting post fitted with a bolt and secured in place with a security nut.

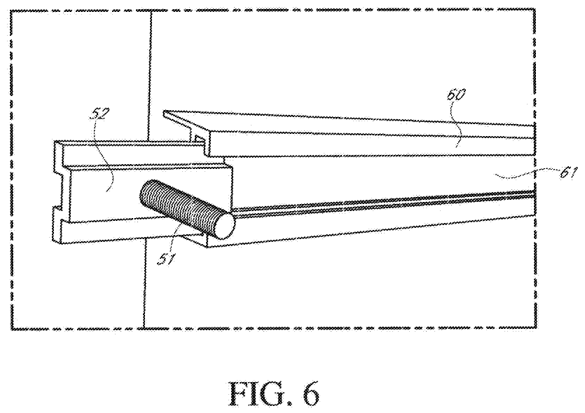

FIG. 6 is a perspective view of a channel slide fitted with a bolt and partially inserted into a channel of a mounting rail.

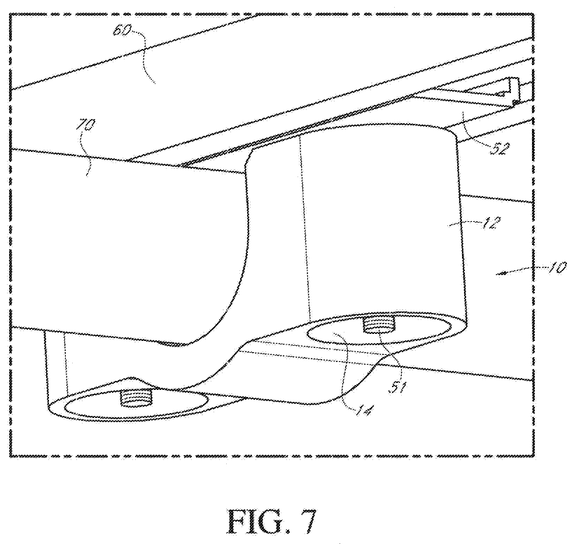

FIG. 7 is a perspective top view of security mounting bracket device with rounded bridge and a round crossbar mounted to a mounting channel by the security mounting bracket device device.

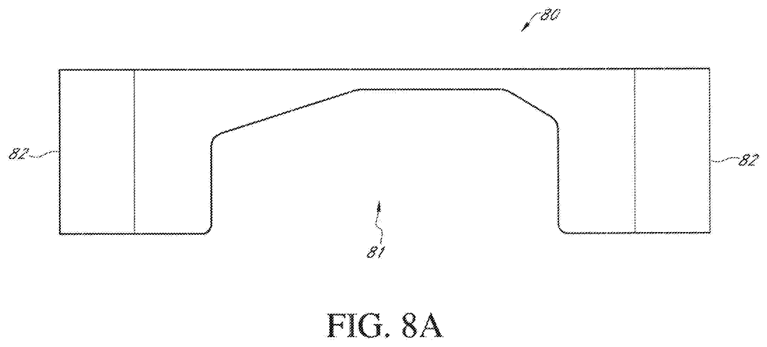

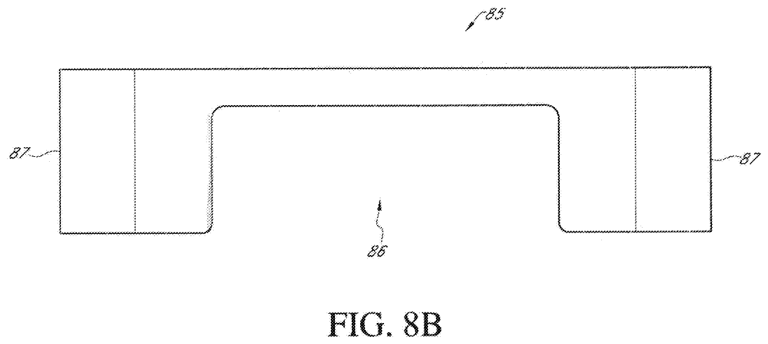

FIGS. 8A-8B are a side view of security mounting bracket device with exemplary variations of the contoured shape of the bridge.

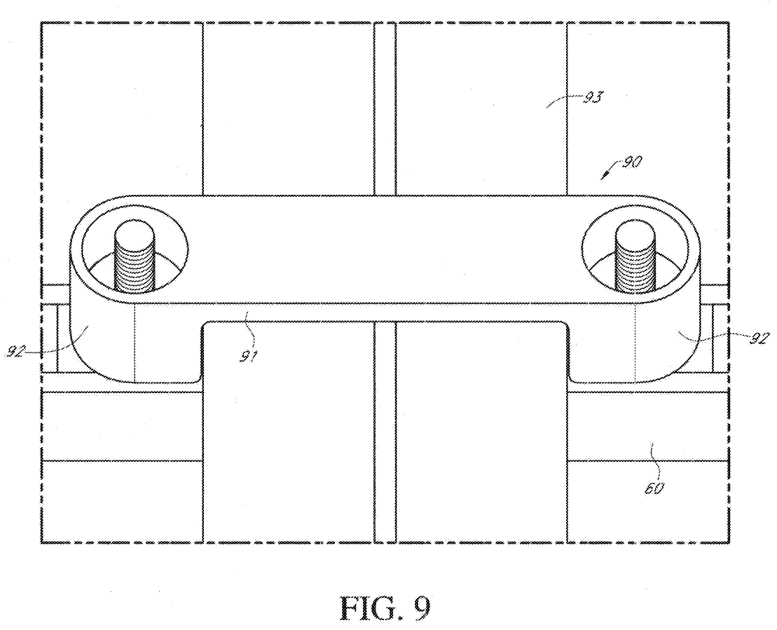

FIG. 9 is a perspective top view of wider security mounting bracket device mounting a flat cross bar to a mounting rail.

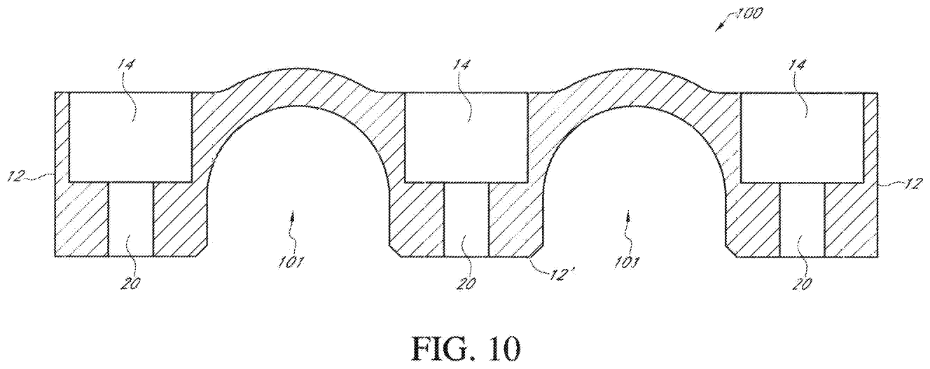

FIG.10 is a side cross sectional view of security mounting bracket device with two rounded bridge and three mounting posts for a two-crossbar attachment.

Corresponding reference numerals indicate corresponding parts throughout the several views of the drawings. For parts which are similar but not the same as parts originally specified with a given number, a prime (′) of the original numbers is used. A lowercase reference numeral (e.g. a, b, etc.) refers to the same part but in different positions or states.

### DETAILED DESCRIPTION

Definitions

Unless defined otherwise, all technical and scientific terms used herein have the same meaning as is commonly understood by one of skill in the art to which the invention(s) belong. All patents, patent applications, published applications and publications, databases, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it understood that such identifiers can change and particular information on the internet can come and go, but equivalent information can be found by searching the internet. Reference thereto evidences the availability and public dissemination of such information.

As used herein, “security mounting bracket” refers to a bracket that connects a crossbar to a mounted object and includes at least two counterbore holes for the placement of a bolt and a security nut, wherein a bolt can pass through the length of the mounting post of the security mounting bracket device and a security nut can fit within the counterbore hole well, below the surface of the security mounting bracket. As described elsewhere herein the security mounting bracket device is customized to the shape of the crossbar.

As used herein, “bridge” refers to a part of the security mounting bracket device that joins two mounting posts of the security mounting bracket”

As used herein, “mounting post” refers to a part of the security mounting bracket device that contains a counterbore hole and two of the mounting posts with the bridge portion form the contoured shape of the security mounting bracket device that straddles the crossbar.

As used herein, “tunnel” refers to the opening fitted to a cross bar and formed by the bridge and two mounting posts of the security mounting bracket.

As used herein, “counterbore hole”, refers to a hole in the device that includes a counterbore hole well and counterbore hole bolt entry end wherein a cylindrical flat-bottomed hole, the well, enlarges another coaxial hole, the bolt entry end, and functions to secure a bolt with a nut, preferably a security nut. The larger diameter hole, the counterbore hole well, is wide enough and deep enough to completely enclose a the nut and together with the narrower coaxial hole span the entire height of the security mounting bracket device mounting post.

As used herein, “contoured” refers to the shape designed to form a close fit between the security mounting bracket device and a crossbar. The contoured shape of the security mounting bracket device is formed by the bridge and two mounting posts of the security mounting bracket, and is matched to the shape of the crossbar straddled by the security mounting bracket.

As used herein, “security nut” refers to an externally grooved or pitted nut that requires the use of a matching socket to unscrew/screw the nut onto a bolt. The shape of the nut can include a conical shape or a cylindrical shape. A security nut can be obtained for example from Loss Prevention Fasteners of Canada at www.losspreventionfasteners.com.

As used herein, “security socket” refers to a socket that is a complementary match to the security nut and is required to fit within the counterbore hole to unscrew/screw the nut from/to a bolt.

As used herein, “nylon-insert lock nut” also referred to as a nyloc nut, polymer-insert lock nut, or elastic stop nut, is a nut with a nylon insert that keeps metric bolt threads from coming loose due to vibration, wear, and temperature. A nylon-insert lock nut may be obtained from e.g. www.mcmaster.com/nylock-nuts.

As used herein, “crossbar” refers to bar that is mounted, or straddled, by the security mounting bracket device and can take on various shapes and sizes as described further below.

As used herein, “mounting channel rail” refers to a slide rail assembly with channel formed within a strip that serves as a guide for a mounting channel slide wherein the overhang of the two opposing walls of the mounting rail grip and hold a mounting channel slide. The mounting rail is made of strong material such as aluminum, stainless steel, titanium, zin alloys or hard plastic.

As used herein, “mounting channel slide” refers to a strip that fits and slide within the channel of the mounting channel rail.

As used herein, “mounted object” refers to any object that is connected to a crossbar by the security mounting bracket.

As used herein, “primary mounted object” refers to any object that is directly connected to the security mounting bracket device by a bolted join such as a mounting channel slide.

As used herein, “secondary mounted object” refers to any object that is connected to a crossbar by the security mounting bracket device through a primary mounted object. A secondary mounted object can include a tent, luggage rack, a bike rack, a storage tub.

As used herein, “plate” refers to primary mounted object that is a flat structure made of a hard material and is fitted with a hole whose diameter is larger than the diameter of the bolt shaft and smaller than the diameter of the bolt head. The plate can function as a mounting channel slide to form a bolted joint between a mounting rail and the security mounting bracket device or can be the base or platform of a secondary mounted object.

As used herein, “platform” refers to the base of a secondary mounted object.

The Safety Mounting Bracket Device

Provided herein is a safety mounting bracket device that can be used to reversibly secure a crossbar to a mounted object. The mounted object can be for example a rod, a bar, a metal plate or a platform that may or may not include a mounting channel bar. The security mounting bracket device has a custom contoured tunnel formed by the bridge and the mounting posts that can straddle a bar of a selected shape, for example the shape can include a pipe or rod that is round, rectangular, square, elliptical or the bar can be textured with grooves, channels or ridges. The bridge and mounting posts of the device can be shaped to attach a cross bar perpendicular to the mounting bracket device bridge or at an angel other than a 90° . As the tunnel portion of the security mounting bracket device is deep and molded out of one piece of material the angle of the tunnel walls with respect to the line of security mounting bracket device formed between the centers of the two mounting posts can vary for example from 90° to 45°. The two mounting posts, one on each side of the bridge, include a counterbore hole with a wide well cylindrical hole adjacent to the top of the mounting bracket device and bridge, and a narrower coaxial cylindrical hole at the bottom of the mount. The wider well opening provides a space for a security nut to fit inside the device and to secure a bolt within the bore hole, without leaving the security nut exposed outside of the device. A matching security socket is required to reach the nut and to screw and unscrew a bolt that passes through the bore hole of the device. The narrower cylindrical hole of the counterbore at the bottom of the mounting bracket device serves as the entry point of the bolt that passes through a hole of a primary mounted object, prior to entering the bore hole of the device. The head of the bolt, secured by the device and the security nut, holds the primary mounted object, for example a second bar, a channel guide, a sheet, a plate, or platform, to the crossbar straddled by the bridge and the mounting posts of the device. A secondary mounted object can be attached to the primary mounted object and can include for example a tent, a container, or a bike rack. The secondary object must be fitted with a means of attachment to the primary mounted object, for example a channel guide to secure the object to a bolt connected to a channel slide.

Optionally the security nut can be replaced with a nylon-insert lock nut or other nut that will form a tight grip with the bolt.

The device is made of a strong hard material that will not be altered by ambient heat and pressure exerted by the cross bar and mounted object and can include material such as aluminum, steel or stainless steel, titanium, zin alloys or hard plastics. In one embodiment the material is aluminum metal selected for its strength, durability, and light weight. The choice of the material used are within the level of a skilled artisan.

The device, including exemplary embodiments of the device, will be described with reference to the accompanying drawings. As indicated, the use of a prime 0 designation with a number indicates that the element shown or described is the same as the non prime element, except as shown or described differently.

In a general embodiment, the security mounting bracket device provided herein, includes bridge, mounting posts, a contoured tunnel formed by the bridge and mounting posts, and a counterbore hole within each mounting post.

For example, with reference to FIG. 1. which illustrate a first exemplary embodiments provided herein, the security mounting bracket device is indicated generally by the reference numeral 10, includes 12 security mounting bracket device mounting posts, bridge 13, counterbore hole wells 14. The underside of the security mounting bracket device 10 is exemplified in FIG. 2 an includes 12 security mounting bracket device mounting posts, bridge 13, and counterbore narrower hole 20 that serves as the bolt entry point. FIG. 3A shows a side cross sectional view of security mounting bracket device 10 with rounded bridge 13, counterbore hole wells 14, and counterbore hole bolt entry ends 20.

The security mounting bracket device 10 bridge 13 and mounting posts 12 form a contoured fit with a crossbar minimizing the space between the mount and crossbar and reducing movement of the mounted object, especially when in motion, and reducing the space that could be accessed for example by a bar to pry the mounted object off the security mounting bracket device. In reference to FIGS. 1-3A, the crossbar with a round shape portion can fit in the contoured bridge 13 and mounting posts 12. The cross sectional view of security mounting bracket device 10 with rounded bridge, exemplified in FIG.3A, provides a view of the counterbore wells 14, that reach into the mounting posts 12 and provide an opening for the placement of a security nut. The counter bore spans the entire height of the mounting posts 12 of the mounting bracket device to allow a bolt to pass through the mounting bracket device and form a connection with the mounted object.

The wider cylindrical well of the counterbore provides a space for a security nut to fit inside the device and secure a bolt within the bore hole, without leaving the security nut exposed outside of the device. A matching security socket is required to reach the nut and to screw and unscrew a bolt that passes through the bore hole of the device. The narrower opening at the bottom of the mounting bracket device serves as the entry point of the bolt that passes through a hole of a primary mounted object, prior to entering the bore hole of the device.

The dimensions of the exemplary security mounting bracket device of FIGS. 1-3A are provided in FIGS. 3B-3D wherein FIG. B includes height of post 3h; length of security mounting bracket devise 3w; height of security mounting bracket devise 3r; width of security mounting bracket devise 3s; Width of tunnel 3t. FIG. 3C provides distance between borehole centers 3x; diameter of small borehole 3y; diameter of large borehole 3z. FIG. 3D provides height of tunnel 3q; Depth of small borehole 3u; width of tunnel 3v.

FIG. 4 illustrates an exemplary security nut that fits within the counterbore cylindrical wells, 14. The security nut has a grooved and/or ridged surface that requires the use of matching socket to access the security nut.

FIG. 5 illustrates the use of the security mounting bracket device in securing a mounted object to a cross bar. The frontal cross sectional view of a rounded bridge 13 and security mounting bracket device 10 illustrates the placement of a bolt 51 within the mount, first passed through the first mounted object, exemplary mounting channel slide 52, and through the counterbore hole to the well 14 where the bolt is secured in place by the security nut 40.

An exemplary connection between the primary mounted object and the secondary mounted object is provided in FIG. 6 where the first mounted object, a channel slide 52, is inserted in part within a channel 61 of a mounting rail 60. A mounting rail can be secured to the bottom of a platform for various object including vehicle tent. The mounting of mounting channel 61 to a crossbar 71 by the security mounting bracket device 10 is exemplified in FIG. 7 with a round pipe provided a the crossbar 71. The security mounting bracket device 10, bridge 13 and mounting posts 12 contoured to fit the round shape of a crossbar, straddles the crossbar and its base is tightly secured to the mounting channel slide 52 secured within a mounting rail 60. A bolt 51 end is visible within the well 14 and the security nut is dep within the well (not shown) exposed. The security mounting bracket device 10, as shown mounted in FIG. 7, cannot easily be removed without the use of a security socket that is a complimentary match to the surface of a security nut. The security nut cannot be cut off as it is deep within the security mounting bracket device 10 well 14 and the tight fit between the security mounting bracket device 10 and slide does not provide room for a typical bolt cutter or saw to reach bolt 51.

In further embodiments of the security mounting bracket device device, exemplified in FIGS. 8A, 8B and 9, the shape of a of the security mounting bracket device is customized to fit crossbars of various shapes. The security mounting bracket device 80, as shown in FIG. 8A, is designed to straddle a wide, ridged crossbar as shown in the outline of the bridge 81 and mounting posts 82. The security mounting bracket device 85 and the contour of bridge 86 and mounting posts 87 is designed to straddle a rectangular shaped crossbar (see FIG. 8B). FIG. 9 provides yet another embodiment of a security mounting bracket device 90 with a wide bridge 91 and mounting posts 92 contoured and mounted over a wide crossbar 93 to a rail 60.

In yet another embodiment a security mounting bracket device can connect two or more crossbars to a mounted object. For example, FIG. 10 shows a security mounting bracket device 100 with two bridges and three mounting posts. In this exemplary view the two bridges 101 are designed to secure two round crossbars (not pictured). The two external mounting posts 12 and one internal mounting post 12′ are each fitted with a counterbore well 14 and narrow counterbore end 20 for bolt entry. The central mounting post 12′ may or may not be secured with a bolt and security nut.

The contoured fit of the security mounting bracket device can be customized to conform to other sizes and shapes of rooftop tent racks, e.g. square, rectangular, or elliptical.

In some embodiments the security mounting bracket device can be about 0.5 inches to 12.0 inch, or 0.75 inches to 10.0 inch, or 1.0 inches to 8.0 inch, or 2.0 inches to 6.0 inch, or 2.5 inches to 5.0 inches wide.

In some embodiments the security mounting bracket device can be about 0.5 inches to 12.0 inch, or 0.75 inches to 10.0 inch, or 1.0 inches to 8.0 inch, or 2.0 inches to 6.0 inch, or 2.5 inches to 5.0 inches high.

In some embodiments the counterbore well 14 the security mounting bracket device can be about 0.5 inches to 12.0 inch, or 0.75 inches to 10.0 inch, or 1.0 inches to 8.0 inch, or 2.0 inches to 6.0 inch, or 2.5 inches to 5.0 in diameter.

Ins some embodiments the counterbore well 14 the security mounting bracket device can be about 0.5 inches to 12.0 inch, or 0.75 inches to 10.0 inch, or 1.0 inches to 8.0 inch, or 2.0 inches to 6.0 inch, or 2.5 inches to 5.0 inches deep.

In some embodiments the counterbore hole of the security mounting bracket device can be about 0.5 inches to 12.0 inch, or 0.75 inches to 10.0 inch, or 1.0 inches to 8.0 inch, or 2.0 inches to 6.0 inch, or 2.5 inches to 5.0 inches long.

The security mounting bracket device is custom designed to match the shape and the size of the tunnel, formed by the bridge and two mounting posts of the security mounting bracket device, to that of the crossbar to which an object is mounted. In further embodiments the size and shape of the tunnel, as well as the size of the counterbore hole and the nut and bolt selected, can vary based on the dimensions the crossbar to be mounted.

Although the invention has been described in detail with reference to certain preferred embodiments, variations and modifications exist within the scope and spirit of one or more independent aspects of the invention as described.

### EXAMPLES

### Example 1

A Security Mounting Bracket Device for a Round Crossbar

A Security Mounting Bracket Device for a Round Crossbar, 1.125

The security mounting bracket device as exemplified in FIGS. 1-7 includes a bridge 13 and mounting posts 12 fitted with a counterbore well 14 and counterbore hole bolt entry end 20 for the placement of a bolt 51 through the mounting bracket device securing a mounted object around a crossbar 70 to the device. The exemplary device is made of aluminum and is 3.65 inches wide (mounting post to mounting post) and 1.33 inches high at height of bridge to base of mount. The mounting posts are 1.25 inches wide and 1.19 inches high. The arch of the bridge opening is 1.14 inches wide and can accommodate a crossbar of about a 1.12 inches. The counterbore hole well 14 is 1.02 inches wide and the narrower counterbore hole bolt entry end 20 is 0.38 inches wide. The distance between the two counterbore holes (center to center) is 2.4 inches. The depth of the narrow bore is 0.44 inches and the height of the tunnel from the base to the top of the arch is 1.01 inches. The crossbar must easily fit within the contoured bridge leaving little space between crossbar and mounting bracket device exposed.

The points on the security mounting bracket device used to provide the dimensions of Example 1 are exemplified in FIGS. 3B-3D.

Dimensions of the two additional designs, 1.5″ and 1.75, are provided below.

A Security Mounting Bracket Device for a Round Crossbar,

The “1.5” security mounting bracket device is 4.04 inches wide (mounting post to mounting post) and 1.57 inches high at height of bridge to base of mount. The mounting posts are 1.25 inches wide and 1.37 inches high. The arch of the bridge opening is 1.515 inches wide and can accommodate a crossbar of about a 1.5 inches. The counterbore hole well 14 is 1.02 inches wide and the narrower counterbore hole bolt entry end 20 is 0.375 inches wide. The distance between the two counterbore holes (center to center) is 2.79 inches. The depth of the narrow bore is 0.62 inches and the height of the tunnel from the base to the top of the arch is 1.258 inches.

A Security Mounting Bracket Device for a Round Crossbar, 1.75

The “1.75” security mounting bracket device is 4.29 inches wide (mounting post to mounting post) and 1.82 inches high at height of bridge to base of mount. The mounting posts are 1.25 inches wide and 1.49 inches high. The arch of the bridge opening is 1.77 inches wide and can accommodate a crossbar of about a 1.75 inches. The counterbore hole well 14 is 1.02 inches wide and the narrower counterbore hole bolt entry end 20 is 0.38 inches wide. The distance between the two counterbore holes (center to center) is 3.04 inches. The depth of the narrow bore is 0.74 inches and the height of the tunnel from the base to the top of the arch is 1.51 inches.

### Example 2

Placement of a Vehicle Top Tent on a Vehicle Roof Rack Using the Security Mounting Bracket.

An operator places a rooftop tent on top of two crossbars, crossbar 70 exemplified, so that the mounting channel 61 is perpendicular to the crossbars 70. Each of two mounting channel slides 52 hold the bolt 51 and fit into the mounting channel 61 on either side of the crossbar 70. The operator places the security mounting bracket device 10 around the rooftop tent crossbar 70 so that the security mounting bracket device 10 straddles the crossbar 70 and the bolts 51 slide inside the counterbore hole narrow end 20 through the counterbore hole 14 located in each of the mounting posts 12. Using a proprietary security socket, the operator would then screw a security nut 40 onto each of the bolts 51 fastening security mounting bracket device around the crossbar 70 and tighten the fit to the mounting rail 61.

Once all four security mounting brackets are fastened tightly across the crossbars 70, the tent will be secured to the vehicle. The tent is safe from theft because the mounts include a proprietary security socket in order to remove the tent. The security mounting bracket device mounting posts 12 are long enough to cover the bolts 51 completely so that bolt cutters cannot be used to cut the bolts and remove the tent. The countertop bore hole 14 is deep so that the security nuts 40 cannot be pried off with pliers. The security mounting bracket device 10 conforms to the shape of the crossbars 70 so that the mounts are more durable and do not bend.

Since modifications will be apparent to those of skill in the art, it is intended that this invention be limited only by the scope of the appended claims.

1. A security mounting bracket device for mounting an object to a crossbar the security mounting bracket device comprising:
a) a single piece of molded material having one or more bridge portions each bridge portion positioned between two mounting posts wherein each mounting post having a top portion and a bottom portion;
b) a counterbore hole centered within each mounting post, spanning the height of each post, wherein a first portion comprises a counterbore hole well positioned in the top portion of the mounting post connected to the bridge portion and is dimensioned for placement of a nut below the surface of the post, and the second portion comprises counterbore hole bolt entry end positioned in the bottom portion of the mounting post; and
wherein the bridge and two mounting posts form a contoured tunnel matching the contour and dimensions of the crossbar.

2. The security mounting bracket device of claim 1, wherein the material will not be altered by ambient heat and pressure exerted by the cross bar and mounted object

3. The security mounting bracket device of claim 1, wherein the material is a hard metal, metal alloy, composite material, polymers.

4. The security mounting bracket device of claim 3, wherein the material is selected from among aluminum, steel, titanium, zinc alloys and hard plastic.

5. The security mounting bracket device of claim 1, wherein the width of the security mounting bracket device as measured form the outer portion of the mounting posts is from or from about 1.0 in to 10.0 or 1.0 in to 24.0 in or 1.0 ft to 5.0 ft and is determined but the width or diameter of the crossbar.

6. The security mounting bracket device of claim 1, wherein the counterbore hole well has a depth between 0.2 in and 1.0 in, or 0.3 in and 0.9 in, or 0.4 and 0.8 in.

7. The security mounting bracket device of claim 1, wherein device comprises two bridge portions with three post portions with the two bridges connected to a shared central post that optionally includes a counterbore hole.

8. The security mounting bracket device of claim 1, wherein the walls of the contoured tunnel formed by the bridge and mounting posts is perpendicular to the alignment of the posts of the security mounting bracket.

9. The security mounting bracket device of claim 1, wherein the walls of the contoured tunnel formed by the post are parallel and not perpendicular to the alignment of the posts of the security mounting bracket.

10. The security mounting bracket device of claim 7, wherein the walls of the contoured tunnel formed by the post are parallel and form an angle that is less than 90° with the alignment of the posts of the security mounting bracket.

11. Method of mounting an object fitted with a mounting rail to a crossbar comprising:
using the security mounting bracket device of claim 1 comprising:
a) placing a bolt through a hole of mounting channel slide and inserting the mounting channel slide into the channel of the mounting rail wherein the head of the bolt is positioned between the mounting channel slide and the mounting rail leaving the unthreaded and threaded shank exposed beneath the mounting channel slide;
b) repeating step a) with a second bolt and aligning the two bolts suspended from the mounting rail a distance equal to the distance between two counterbore bolt entry holes of a security mounting bracket device;
c) straddling a crossbar, perpendicular to and below the mounting channel rail, with the security mounting bracket device, inserting the two bolts through the two post of the security mounting bracket device positioning the threaded shank of the bolt within the well of the counterbore hole;
d) using a nut and socket, placing the nut onto the threader shank of the bolt and tightening the nut onto the bolt and forming a bolted joint between the security mounting bracket device and the mounting channel rail; and
wherein a bolted join is formed between teach of two security mounting bracket devices and mounting rail.

12. The method of claim 12 wherein the nut is selected from among security nut and a nylon-insert lock nut.

13. Method of mounting an object fitted with two mounting rails to a crossbar comprising:
using the security mounting bracket device of claim 1 comprising:
a) placing a bolt through a hole of mounting channel slide and inserting the mounting channel slide into the channel of a first mounting rail wherein the head of the bolt is positioned between the mounting channel slide and the first mounting rail leaving the unthreaded and threaded shank exposed beneath the mounting channel slide ;
b) repeating step a) with a second bolt and aligning the two bolts suspended from the mounting rail a distance equal to the distance between two counterbore bolt entry holes of a security mounting bracket device;
c) straddling a crossbar, perpendicular to and below the first mounting rail, with the security mounting bracket device, inserting two bolts through the two post of the security mounting bracket device positioning the threaded shank of the bolt within the well of the counterbore hole;
d) using a nut and socket, placing the nut onto the threader shank of the bolt and tightening the nut onto the bolt and forming a bolted joint between the security mounting bracket device and the first mounting rail, wherein a bolted join is formed between teach of two security mounting bracket devices and mounting rail;
e) repeating steps a)-d) with a second mounting rail and a second set of bolts, nuts, mounting channel guides; and
wherein a bolted join is formed between teach of four security mounting bracket devices and two mounting rail.

14. The method of claim 13 wherein the nut is selected from among security nut and a nylon-insert lock nut.

15. The method of claim 13 wherein the mounted object is selected from among vehicle top tent, a bike rack, a cargo box.
